(19) United States
(12) Patent Application Publication
(10) Pub. No.: US 2019/0366507 A1
(43) Pub. Date: Dec. 5, 2019

(54) BLASTING PROBE FOR INTRODUCING A GRANULAR BLASTING MATERIAL INTO A CAVITY

(71) Applicant: TUNAP GMBH & CO. KG, Wolfratshausen (DE)

(72) Inventor: Alfons URBAN, Bad Heilbrunn (DE)

(21) Appl. No.: 16/477,751

(22) PCT Filed: Jan. 10, 2018
(86) PCT No.: PCT/EP2018/050507

§ 371 Date: Jul. 12, 2019

(30) Foreign Application Priority Data
Jan. 13, 2017 (DE) 20 2017 100 159.8

(51) Int. Cl. B24C 3/32; B24C 5/04

(52) U.S. Cl. CPC B24C 3/325; F02B 77/04; B24C 5/04

(57) ABSTRACT

The invention relates to a blasting probe for introducing a granular blasting material into a cavity, in particular into a narrow coked cavity such as an inlet channel of a valve of an internal combustion engine, in particular for cleaning said cavity, comprising a blasting pipe (connectable, at a rear end thereof, to a blasting material feeding line, and a blasting nozzle at the front end of the blasting pipe, said blasting nozzle having at least one outlet opening for the blasting material which is radial with respect to the longitudinal axis of the blasting pipe and which is associated with a deflector surface arranged obliquely with respect to the longitudinal axis of the blasting pipe.

### BACKGROUND OF THE INVENTION

### Field of the Invention

The present invention relates to a blasting probe for introducing a granular blasting material into a cavity, in particular for cleaning the cavity, and to a device for cleaning cavities provided with a blasting probe according to the invention.

### Description of Related Art

From DE 10 2010 039 696.6, a device for cleaning coked cavities, in particular inlet channels and valves of an internal combustion engine, is already known, said device including a first probe, which is provided, at the leading end thereof, with one or more nozzles for injecting an alkaline liquid into the cavity to be cleaned and which is connected, at the other end thereof, to the delivery side of a pump, wherein an alkaline liquid can be supplied to the intake side of said pump. Here, the alkaline liquid to be introduced into the cavity to be cleaned, for example into an inlet channel of a valve of an internal combustion engine, may consist of a mixture of a solvent and a base in solid form. When using such an alkaline liquid, it is possible to inject it into the cavity to be cleaned via nozzles radially arranged on the probe.

From EP 2 565 416 A1, another device for cleaning coked cavities, in particular inlet channels and valves of an internal combustion engine, is known, wherein a cleaning jet probe has, in addition to a liquid line, a powder jet pipe, though which a blasting material is introduced by means of compressed air into the cavity to be cleaned such that the granular blasting material removes the contaminants from the walls of the cavity to be cleaned in a manner similar to sand blasting. Since a solvent is introduced into the cavity through a liquid line in the cleaning jet probe at the same time as the granular cleaning powder in order to form a cleaning liquid for removing contaminants, the abrasive effect of the cleaning powder serves to prepare and assist the cleaning operation by means of cleaning liquid.

However, when cleaning of the cavity is to be performed in a two-step process, which allows for easier handling during the cleaning of input channels and valves of an internal combustion engine in a workshop when the engine is installed, it is difficult to direct the cleaning powder jet ejected from the axially arranged outlet opening of the powder jet pipe towards all areas of the walls of the cavity to be cleaned in a targeted manner.

One way to control the direction of the cleaning powder jet is to deflect/bend the outlet region of the powder jet pipe, so that the powder jet also has a radial component in addition to an axial component. In order to be able to completely apply the cleaning powder in a cylindrical cavity in the circumferential direction, however, it is necessary to be able to rotate the powder jet pipe by 360° about its longitudinal axis, which is virtually impossible in narrow inlet channels.

### BRIEF SUMMARY OF THE INVENTION

In light of the above, it is the object of the present invention to provide a blasting probe for introducing a granular blasting material into a cavity, which makes it possible to ensure, even for tight cavities, that the granular blasting material used to clean can be applied to all the walls of the cavity so as to completely remove the contaminants.

This object is achieved by the blasting probe according to claim 1.

Advantageous embodiments and further developments of the invention are described in the dependent claims.

According to the invention, a blasting probe for introducing a granular blasting material into a cavity for cleaning said cavity comprises a blasting pipe the outlet end of which is assigned a blasting nozzle which has a radial outlet opening assigned with a deflector surface arranged obliquely with respect to the opening surface and obliquely with respect to the longitudinal axis of the blasting pipe. This ensures that the blasting material transported through the blasting pipe of the blasting probe by compressed gas, in particular compressed air, is deflected via the deflector surface in the radial direction such that it exits the blasting pipe of the blasting probe not only in the forward direction, but also transversely.

The use of a blasting nozzle according to the invention at the outlet-side end of the blasting probe thus provides an angled blasting material jet, which can be guided by simply rotating the blasting pipe about the longitudinal axis thereof over the entire circumferential region. The blasting pipe of the blasting probe has no bends, so that it can be rotated fully by 360° even in the narrowest cavities, in which it can be inserted straightly, such that blasting material can be reliably applied to the walls of the narrowest cavities, in particular intake channels of intake valves of internal combustion engines and the walls can be cleaned properly.

In order to not only be able to clean surfaces located next to the outlet end of the blasting pipe of the blasting probe, but also surfaces located in front of the blasting probe, an angle between the deflector surface and the longitudinal axis of the blasting pipe is set to be between 50° and 20°, preferably between 40° and 30°, in particular about 35°.

The special angular arrangement of the deflector surface relative to the longitudinal axis of the blasting pipe, i.e. to the transport direction of the blasting material through the blasting pipe, ensures that the blasting stream has both a radial component and an axial component, so that the granular blasting material can be applied to areas both to the side and in front of the tip of the blasting probe.

In order to ensure that the blasting material does not hit the edges of the outlet opening, advantageously, the deflector surface is curved concavely.

In an advantageous further development of the invention, the outlet opening is formed by an elongated hole extending in the longitudinal direction of the blasting pipe, the length of the deflector surface being approximately one third to four fifths of the length of the elongated hole, as viewed in the longitudinal direction of the blasting pipe.

By using an elongated hole as the outlet opening, a blasting material jet divergent in particular in the axial direction of the blasting probe can be obtained, which can cover broad strips on the walls of the cavity to be cleaned. As a result, the handling of the blasting probe for cleaning cavities is further simplified.

In order to further improve the effectiveness of the blasting probe according to the invention, in an advantageous embodiment of the invention, the blasting nozzle has a plurality, preferably three, radial outlet openings distributed uniformly in the circumferential direction of the blasting pipe. By using a plurality of outlet openings distributed uniformly in circumferential direction, a cleaning blasting material jet is obtained, which can be guided through a cylindrical cavity such as the inlet channel of a valve in internal combustion engines in a manner substantially similar to a bottle brush. When, for example, three outlet openings of the blasting nozzle distributed uniformly in the circumferential direction are provided, the blasting probe only needs to be rotated by a little more than 120° about its longitudinal axis in order to apply the blasting material to 360° of the surrounding walls.

In a particularly advantageous embodiment of the invention, the blasting nozzle has a nozzle body which has a bore extending in the longitudinal direction of the blasting pipe, which forms a blasting material channel opening into the radial outlet openings, the blasting direction side end of which is formed by the deflector surfaces forming a roof-shaped or pyramid-shaped deflecting body.

By providing the blasting nozzle with a nozzle body the blasting material channel forming bore of which is used to insert the front end of the blasting pipe of the blasting probe and which is welded, in particular spot-welded, to the blasting pipe, the production of the blasting probe according to the invention can be simplified. In particular, this makes it possible to easily produce blasting probes of different lengths. Inserting the blasting pipe into the bore of the nozzle body furthermore ensures that the blasting material channel in the nozzle body has a larger diameter than the blasting material jet emerging from the blasting pipe, so that the effect of the blasting material jet on the inner walls of the bore in the nozzle body is reduced, whereby the service life of the nozzle body is significantly increased.

In order to further increase the service life, i.e., the durability, of the blasting probe, in another embodiment of the invention, the nozzle body, in particular the deflecting body, is hardened.

Particularly advantageously, the blasting probe according to the invention is used with a device for cleaning cavities, the device comprising a blasting material feeding line connectable to the rear end of the blasting probe the input end of which is connected to a device connected to a blasting material source and connectable to a source of compressed gas via a compressed gas line in order to mix granular blasting material with a compressed gas. Such a device for cleaning cavities can conveniently be used in the workshop, since there is usually compressed air as compressed gas available for a variety of applications, which can then be used together with cleaning powder as a granular blasting material to clean cavities, in particular narrow coked cavities in internal combustion engines without their disassembly.

### BRIEF DESCRIPTION OF THE DRAWINGS

Exemplarily, the invention will be explained in more detail below with reference to the drawing. Show it:

FIG. 1 is a simplified schematic block diagram of a device for cleaning cavities with a blasting probe according to the invention;

FIG. 2 is a simplified schematic sectional view of a cavity to be cleaned in an internal combustion engine during a cleaning process by means of a blasting probe according to the invention;

FIG. 3 is a plan view of a blasting probe according to the invention according to a first embodiment of the invention;

FIG. 4 shows a sectional view through the front end of the blasting probe according to the invention shown in FIG. 3;

FIG. 5 shows a blasting probe according to a preferred embodiment of the invention;

FIG. 6 is a sectional view substantially taken along line VI-VI in FIG. 5; and

FIGS. 7A to 7C show simplified representations of the blasting probe according to the invention for illustrating the blasting material streams emerging from the various blasting nozzles.

Throughout the various figures of the drawing, corresponding components are provided with the same reference numerals.

### DETAILED DESCRIPTION

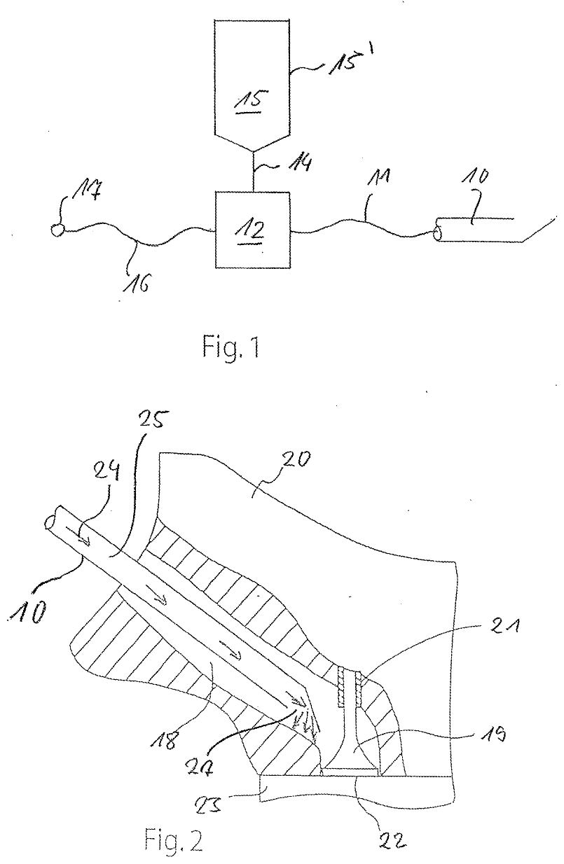

FIG. 1 shows a device for cleaning cavities with a blasting probe 10 connected, at the rear end thereof, to a blasting material feeding line 11, input end of which is connected to a mixing device 12, in which blasting material is mixed with compressed gas, e.g., compressed air, so that the blasting probe 10 can be supplied with a blasting material stream via the blasting material feeding line 11. For this purpose, the mixing device 12 is connected, on the one hand, via a line 14 to a blasting material container 15′ serving as the blasting material source 15 and, on the other hand, connected via a compressed gas line 16 to a compressed gas source (not shown in detail). The compressed gas line 16 is provided with a connector coupling 17 which can be connected, for example, to the compressed air system of a workshop.

In order to mix the granular blasting material with compressed air as a compressed gas, in the mixing device 12, the blasting material, e.g., a cleaning powder, sucked in by the compressed air flowing through the mixing device 12, for example in the manner of a siphon or a water jet pump, and mixed therewith, so that the compressed air, along with the granular blasting material it transports, can be supplied to the blast probe 10 as the blasting material stream 24.

As an example of a cavity to be cleaned, FIG. 2 shows an inlet channel 18 of an inlet valve 19 in a cylinder head 20. The inlet valve 19, which is guided in the cylinder head 20 by means of a valve guide 21, serves to close and open an outlet opening 22 of the inlet channel 18 which simultaneously forms an inlet opening of a cylinder space (not shown) in the cylinder block 23. In the area of the outlet opening 22 and the inlet valve 19, the inlet channel 18 and the inlet valve 14 are prone to coking, so that these inlet channels 18 have to be cleaned from time to time depending on the type of operation of the internal combustion engine.

For this purpose, a cleaning powder as a granular blasting material is blasted against the walls of the inlet channel 18 and the exposed surfaces of the inlet valve 19 such contaminants (not shown in detail in FIG. 2) are removed from the surfaces to be cleaned by the cleaning powder similar to sand blasting. The cleaning powder is introduced as the blasting material stream 24 via a blasting material channel 25 of the blasting probe 10 into the interior of the inlet channel 18 and directed against the inner walls of the cavity by a blasting nozzle 27 provided at the front end of the blasting probe 10. When the blasting probe 10 is rotated about its longitudinal axis, the blasting material stream exiting with a radial component is pivoted correspondingly and the cleaning powder of the blasting stream 24 may act on and clean all the walls of the cavity to be cleaned, i.e., the inner walls of the inlet channel and the surfaces of the inlet valve 19.

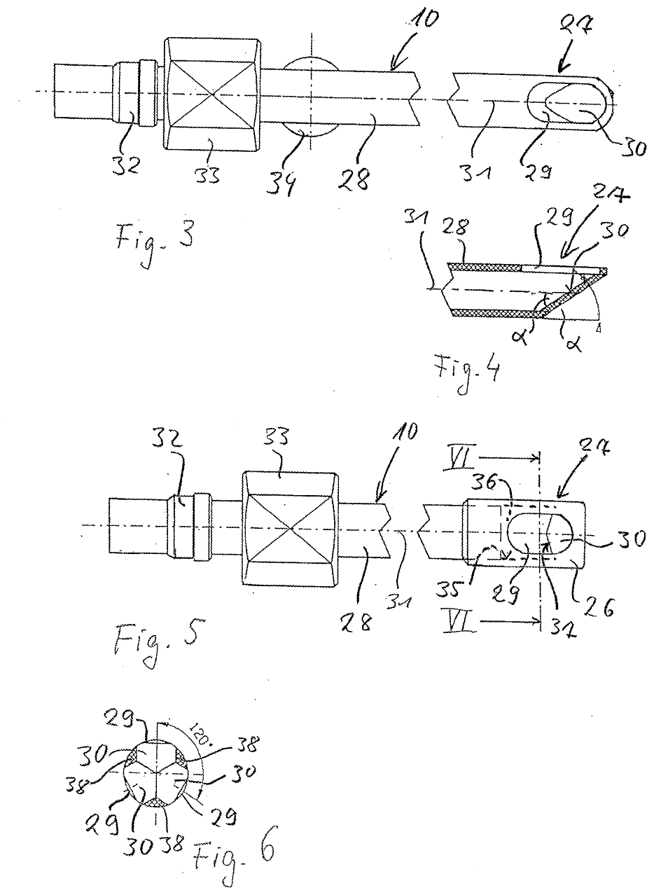

The structure of the blasting probe 10 according to the invention will be explained in more detail with reference to FIGS. 3 and 4.

The blasting probe 10 shown in FIG. 3 comprises a blasting pipe 28, at the front right end of which in FIG. 3 the blasting nozzle 27 is provided. Here, the blasting nozzle 27 comprises a radial outlet opening 29, which is preferably formed as an elongated hole, and a deflector surface 30 arranged obliquely with respect to the longitudinal axis 31 of the blasting pipe, as is particularly apparent in FIG. 4. The angle α between the deflector surface and the longitudinal axis 31 of the blasting pipe is 35° in the illustrated embodiment. However, it can also be larger or smaller depending on the direction in which the blasting material stream is to be directed, which in turn is dependent on the geometry of the cavities to be cleaned. Depending on whether the radial component or the axial component of the blasting material stream 24 emerging from the blasting nozzle 27 should predominate, the angle α is selected to be larger or smaller. Preferably, the angle α is in the range between 50° and 20°, in particular in the range between 40° and 30°. In a blasting probe tested in the laboratory, particularly good cleaning results were achieved in intake channels of intake valves in internal combustion engines with an angle α of 35° between the deflector surface 30 and the longitudinal axis 31 of the blasting pipe 28.

In order to connect the blasting probe 10 with the blasting material feeding line (not shown in FIG. 3), a cutting ring 32 is provided in the region of the end facing away from the blasting nozzle 27 of the blasting pipe 28, the cutting ring 32 along with a cap nut 33 serving to safely screw the blasting material feeding line to the blasting probe 10 in the connection region.

In the rear region of the blasting pipe 28 on the side diametrically opposite to the outlet opening 29 of the blasting nozzle 27, a disc 34 is attached, in particular welded thereto, so that, after the introduction of the blasting nozzle 27 into the cavity to be cleaned, the user of the blasting probe 10 knows, in which direction the blasting material stream 24 emerges from the blasting nozzle 27.

In the blasting probe 10 according to the invention shown in FIG. 5, a blasting nozzle 27 is mounted on the front right end of the blasting pipe 28 in FIG. 5, the blasting nozzle comprising a nozzle body 26 having a bore 35 extending in the longitudinal direction of the blasting pipe 28, which forms a blasting material channel 36 opening into radial outlet openings 29.

The blasting pipe 28 is inserted into the bore 35 of the nozzle body 26 and preferably welded, in particular spot-welded, to the nozzle body 26. Since the diameter of the blasting material channel 35 is greater than the diameter of the blasting material channel 25 in the blasting pipe 28, virtually no blasting material hits the inner peripheral surface of the blasting material channel 35 in the nozzle body 26, whereby the wear is reduced.

As can be seen in FIG. 6, the nozzle body 26 has three outlet openings 29 distributed uniformly in circumferential direction, each having its own deflector surface 30. Thus, the three deflector surfaces 30 form a conical or pyramid-shaped deflection body 37, which is supported by bars 38 between the outlet openings 29. The deflector surfaces 30 are configured such that no blasting material hits the bars 38. For example, the deflector surfaces 30 may be concave thereto.

Instead of three outlet openings 29 distributed uniformly in circumferential direction with corresponding deflector surfaces 30 forming a pyramid-shaped deflecting body 37, two or more outlet openings may be distributed in circumferential direction. When, for example, two diametrically opposite outlet openings are provided, the deflection body formed by the associated deflector surfaces is roof-shaped. When more than three, i.e., four or five, outlet openings distributed uniformly in circumferential direction with corresponding deflector surfaces are provided, the conical deflection body 37 is a quadrangular or pentagonal pyramid.

In order to increase the wear resistance of the deflection body 37, it is preferably hardened.

The outlet openings 29 in the blasting nozzle 27 according to FIG. 5 are also configured as elongated holes. As is apparent in FIGS. 3, 4 and 5, the length of the deflector surfaces 30 in the longitudinal direction of the blasting pipe 28, that is, the projection of the deflector surfaces 30 onto the longitudinal axis 31 of the blasting pipe 28, is shorter than the length of the elongated hole forming the outlet opening 29. In particular, the length of the projection of the deflector surfaces 30 onto the corresponding longitudinal axis 31 of the blasting pipe 28 is about one third to four fifths of the length of the outlet opening 29 forming the elongated hole.

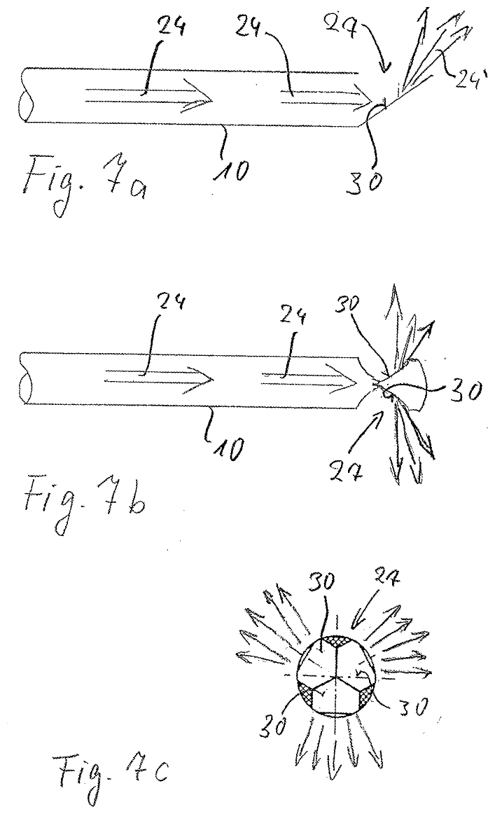

FIGS. 7A to 7C schematically illustrate the deflection of the blasting material stream 24 at the deflector surface(s) 30 of the blasting nozzles 27. As can be seen in FIG. 7A, the divergent blasting material stream 24′ emerging from the outlet opening of the nozzle 27 has both radial and axial components such that the emerging blasting material stream 24′ can be pivoted by 360° by rotation of the blasting probe about its longitudinal axis.

As is apparent in FIGS. 7B and 7C, the embodiment of the invention according to FIG. 5 provides three blasting material streams 24″ which emerge from the corresponding outlet openings 29 of the blasting nozzle 27 and are arranged offset from each other by 120° in circumferential direction in accordance with the arrangement of the outlet openings. In order to be able to cover 360°, it is only necessary to rotate the blasting probe 10 by 120°, so that the blasting material streams 24″ must be pivoted by 120° in order to apply the blasting material, i.e., appropriate granular cleaning agents, to the full circle.

By simple displacement and rotation about its longitudinal axis, the blasting probe 10 according to the invention allows the cleaning powder as a blasting material to be applied to all the walls of a cavity to be cleaned, thereby cleaning the cavity.

1. A blasting probe for introducing a granular blasting material into a cavity, in particular into a narrow coked cavity such as an inlet channel of a valve of an internal combustion engine, in particular for cleaning said cavity, comprising
a blasting pipe connectable, at a rear end thereof, to a blasting material feeding line, and
a blasting nozzle at the front end of said blasting pipe, said blasting nozzle having at least one outlet opening for the blasting material which is radial with respect to the longitudinal axis of said blasting pipe and which is associated with a deflector surface arranged obliquely with respect to the longitudinal axis of said blasting pipe.

2. The blasting probe according to claim 1, wherein an angle α between said deflector surface and the longitudinal axis of said blasting pipe is between 50° and 20°, preferably between 40° and 30°, in particular about 35°.

3. The blasting probe according to claim 1, wherein said deflector surface is concave.

4. The blasting probe according to claim 1, wherein said outlet opening is formed by an elongated hole extending in the longitudinal direction of said blasting pipe.

5. The blasting probe according to claim 4, wherein the length of said deflector surface, viewed in the longitudinal direction of said blasting pipe, is about one-third to four-fifths of the length of said elongated hole.

6. The blasting probe according to claim 1, wherein said blasting nozzle has a plurality of, preferably three, radial outlet openings distributed uniformly in the circumferential direction of said blasting pipe.

7. The blasting probe according to claim 6, wherein said blasting nozzle comprises a nozzle body having a bore, said bore extending in the longitudinal direction of said blasting pipe and forming a blasting material channel which opens into the radial outlet openings and the end of which in the blasting direction is formed by the deflector surfaces forming a roof-shaped or pyramid-shaped deflecting body.

8. The blasting probe according to claim 7, wherein said nozzle body, in particular said deflecting body, is hardened.

9. The blasting probe according to claim 7, wherein the front end of said blasting pipe is inserted into the bore forming said blasting material channel, and that said nozzle body is welded, in particular spot-welded, to said blasting pipe.

10. A device for cleaning cavities, in particular narrow coked cavities such as inlet channels of valves of internal combustion engines, said device comprising
a blasting probe according to one of the preceding claims, and
a blasting material feeding line connected to the rear end of said blasting probe, the input end of said blasting material feeding line being connected to a device which is connected to a blasting material source for mixing granular blasting material with a compressed gas and which is connectable to a compressed-gas source via a compressed-gas line.
